(19) United States
(12) Patent Application Publication
(10) Pub. No.: US 2007/0195911 A1
(43) Pub. Date: Aug. 23, 2007

(54) Radio apparatus with wasteful power consumption diminished without reliance upon analysis by an RSSI and a power control method therefor

(75) Inventor: Yusuke Ochi, Tokyo (JP)

Correspondence Address: NIXON PEABODY, LLP, 401 9TH STREET, NW, SUITE 900, WASHINGTON, DC, 20004-2128, US

(73) Assignee: OKI ELECTRIC INDUSTRY CO. LTD.

(21) Appl. No.: 11/708,003

(22) Filed: Feb. 20, 2007

(30) Foreign Application Priority Data
Feb. 20, 2006 (JP) 2006-42321

(51) Int. Cl. H04L 27/00

(52) U.S. Cl. 375/324

(57) ABSTRACT

A mobile phone terminal device checks, in a Manchester determiner, whether or not demodulated data satisfies a predetermined condition for decision exploiting a feature proper to the Manchester code. The Manchester determiner generates a decision signal representing the state of allowance or inhibition, conforming to the decision, and, responsive to the state of allowance of the decision signal. The Manchester determiner allows the demodulated data stored in a buffer to be output. The decision signal is transferred from the determiner to a radio frequency unit and a demodulator. The operation of the radio frequency unit and the demodulator is halted responsive to the state of inhibition of the decision signal.

### BACKGROUND OF THE INVENTION

1. Field of the Invention

The present invention relates to a radio apparatus and a power control method therefor and, more particularly, to a radio apparatus, such as a mobile phone terminal device or a terminal unit, for information communication, the power consumption of which is to be controlled, as well as to a power control method of controlling power through the control of booting circuitry with the use of pattern analysis of, for example, Manchester coded data.

2. Description of the Background Art

A type of radio apparatus is adapted to be in response to an interrupt by a transmitter timer to boot its a radio frequency (RF) unit, RSSI (Received Signal Strength Indicator) unit, and decision unit to have the radio frequency unit receive high frequency signals. The radio apparatus converts the value of the strength of the received electrical field, received by the radio frequency unit, into a corresponding digital signal, which is then transferred to the decision unit. The radio apparatus decides on, in its decision unit, whether or not the signal is to be transmitted. If the signal is to be transmitted, then the radio apparatus outputs the signal from its transmitter.

In capturing a signal, propagated in air to a receiver, the radio apparatus is operative in response to an interrupt by the timer to boot the radio frequency unit, the RSSI unit and the decision unit to have the radio frequency unit receive a high frequency signal. The radio apparatus converts the value of the strength of the received electrical field in the signal received by the radio frequency unit, into-a digital signal, which is then transferred to the decision unit. The radio apparatus checks, in its decision unit, whether or not the RSSI value is higher than a predetermined threshold value. If the RSSI value is lower than or equal to the threshold value, the radio apparatus gives a decision that no receivable signal is incoming, and accordingly halts the operation of the radio frequency unit, the RSSI unit and the decision unit.

Conversely, if the RSSI value is higher than the threshold value, the radio apparatus gives a decision that a signal of some sort or other is incoming. Responsive to this decision, the radio apparatus boots its demodulator, host interface (Host_TF) unit and controller. The radio apparatus demodulates the received signal, by the demodulator, to transfer the demodulated data to the controller. The controller includes a control circuit which analyzes the pattern of the transferred data. The control circuit decides on, through pattern analysis, whether or not the signal is intended to be addressed to the radio apparatus itself. Based on the results of the pattern analysis, the radio apparatus determines whether data is to be acquired or discarded.

Japanese Patent Laid-Open Publication No. 55228/1999 discloses a transmitter, a receiver and a transceiver designed to solve the difficulties with fading and interfering waves. The receiver includes a demodulator. The demodulator eliminates a carrier component contained in the electromagnetic wave received from a transmitter, encodes the signal, freed of the carrier wave, by Manchester coding, and outputs the resulting signal as an encoded demodulated signal to a Manchester decoder. The Manchester decoder produces, from the demodulated signal, a detection signal identifying an error-corrupted portion of the decoded signal which violates the code rule. The Manchester decoder is responsive to the detection signal to also output a decoded signal in which the signal level of the error-corrupted portion is set to “0”. The receiver combines the decoded signals, from one carrier wave to another, to restore the transmission information. The receiver is thus able to readily identify the error-corrupted portion contained in the decoded signal.

However, the demodulating operation thus carried out by the above-described constitution causes the host interface unit and the controller to be activated each time data analysis is to be carried out, resulting in increased electric power consumption in the radio apparatus. Additionally, during data transfer, following the booting, the controller has to carry out data analysis alone, so that much time is spent until the end of the analysis. The result is the increased power consumption corresponding to this prolonged processing time.

The Japanese publication stated above thus discloses a receiver in which an error-corrupted portion contained in a demodulated signal may readily be identified with the use of a signal encoded by Manchester coding. However, this publication lacks in suggestion and disclosure as to the technique of avoiding the power consumption from increasing.

### SUMMARY OF THE INVENTION

It is therefore an object of the present invention to provide a radio apparatus with which otherwise wasteful electric power consumption conventionally unavoidable may be diminished without-reliance upon analysis by the RSSI in the transmission and reception.

The present invention provides a radio apparatus for receiving a high frequency signal. The radio apparatus includes a frequency converter for converting the high frequency signal into a signal of a base-band frequency and for outputting converted signal, and a demodulator for demodulating the converted signal and for converting the demodulated signal into demodulated digital data. The radio apparatus also includes a determiner for determining whether or not the demodulated digital data satisfies a predetermined condition for decision, which exploits a feature proper to the Manchester code, and for generating a decision signal representing the state of allowance or inhibition resulting from the decision, and a memory for temporarily storing the demodulated digital data from the determiner. The demodulated digital data stored in the memory is output and the decision signal is transferred to the frequency converter and the demodulator responsive to the state of allowance of the decision signal. The operation of the frequency converter and the demodulator is halted responsive to the state of inhibition of the decision signal.

The present invention also provides a radio apparatus for transmitting and receiving a high frequency signal, wherein the radio apparatus includes a frequency converter for converting the high frequency signal into a signal of a base-band frequency, outputting the converted signal and for converting a transmission signal of the base-band frequency into a high frequency signal, a demodulator for demodulating a converted signal and for converting the demodulated signal into demodulated digital data, a determiner for determining whether or not the demodulated data satisfies a condition for decision which exploits a predetermined Manchester code and for generating a decision signal representing the state of allowance or inhibition associated with the decision, a memory for temporarily storing the demodulated data from the determiner, an encoder for encoding transmission signal into a Manchester encoded signal, and a modulator for modulating the transmission data encoded to output the resulting modulated data to the frequency converter. The demodulated digital data stored in the memory is output and the decision signal is transferred to the frequency converter and the demodulator responsive to the state of allowance of the decision signal. The operation of the frequency converter and the demodulator is halted responsive to the state of inhibition of the decision signal.

The present inventional so provides a power controlling method for suppressing the power consumption in the reception of a high frequency signal. The power controlling method of the present invention includes the steps of converting a received demodulated signal into demodulated digital data, determining whether or not the demodulated digital data satisfies a predetermined condition for decision which exploits a feature proper to the Manchester code, and generating a decision signal representing the state of allowance or inhibition resulting from decision. The demodulated digital data is output responsive to the state of allowance of the decision signal, and the frequency conversion and the step of converting are halted responsive to the state of inhibition of the decision signal.

With the radio apparatus according to the present invention, the determiner decides on whether or not demodulated data satisfies the predetermined condition for decision which exploits a feature proper to the Manchester code. The determiner generates a decision signal representing the state of allowance or inhibition which conforms to the result of the decision. The demodulated data stored in the memory is-output responsive to the state of allowance of the decision signal, and a decision signal is transferred to the frequency converter and the demodulator. The operation of the frequency converter and the demodulator is halted responsive to the state of inhibition of the decision signal to disable the operation more quickly than with the conventional system on startup of demodulation. Thus, at least the operation of the frequency converter and the demodulator may be halted to diminish the power consumption. On the other hand, stabilized data transfer for a certain period of time is made possible by storing several bytes in a memory and by subsequently giving a decision, thereby improving the communication quality.

With the radio apparatus according to the present invention, the determiner verifies whether or not the demodulated data satisfies the predetermined condition for decision which exploits a feature proper to the Manchester code. The decision signal indicative of the state of the allowance or inhibition conforming to the decision is generated and, responsive to the state of the allowance of the decision signal, the demodulated data, stored in the memory, is output. The decision signal is transferred to the frequency converter and the demodulator, and the operation of the frequency converter and the demodulator is halted more quickly than before responsive to the inhibition of the decision signal, in such a manner as to provide for prompt halting of the operation on startup of demodulation. At least the operation of the frequency converter and the demodulator may be halted to save the electric power. The Manchester pattern data may be generated within the time one-half as long as that in the conventional system by encoding the transmission data into the Manchester code by the encoder.

Moreover, with the power controlling method according to the present invention, the demodulated signal is converted into demodulated digital data which is then checked as to whether or not it satisfies the predetermined condition for decision which exploits a feature proper to the Manchester code. A decision signal, representing the state of allowance or inhibition, conforming to the decision, is generated, and demodulated digital data is then output, responsive to the state of allowance of the decision signal, in order to allow for recognition of the pattern of unneeded data. The operation of frequency conversion and demodulation is halted responsive to the state of the inhibition of the decision signal. By the above-stated control, the operation may be halted more quickly than with the conventional system, as a result of which wasteful power consumption may be diminished.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a radio apparatus formed as a mobile phone terminal device according to the present invention;

FIG. 2 exemplarily illustrates how Manchester coding is used in the mobile phone terminal device shown in FIG. 1;

FIG. 3 is a flow chart useful for understanding the operational sequence in the mobile phone terminal device shown in FIG. 1;

FIG. 4 is a timing chart for exemplarily illustrating how demodulated data is output which is in keeping with decision given by the Manchester determiner of FIG. 1;

FIG. 5 is a timing chart useful for understanding the conversion of input data in the Manchester determiner of FIG. 1;

FIG. 6 is a timing chart useful for understanding the discarding of demodulated data which is in keeping with the decision given by the Manchester determiner of FIG. 1;

FIG. 7 is a timing chart useful for understanding the encoding in the Manchester encoder of FIG. 1; and

FIG. 8 is a timing chart showing the period of data generated in the control circuit shown in FIG. 1 in comparison with that of received data.

### DESCRIPTION OF THE PREFERRED EMBODIMENTS

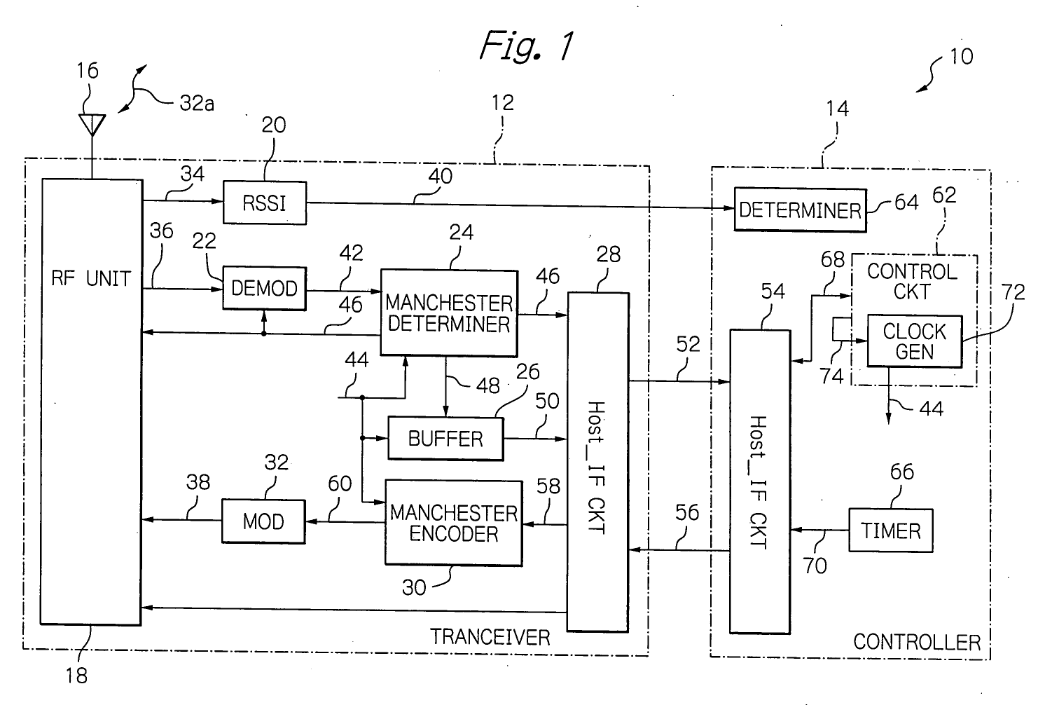

With reference to the accompanying drawings, an embodiment of a radio apparatus according to the present invention will now be described. Referring first to FIG. 1, a preferred embodiment according to the present invention is specifically featured by the fact that a Manchester determiner 24 decides on whether or not demodulated data satisfies the predetermined condition for decision which exploits a feature proper to the Manchester code to produce a decision signal 46 representing the state of the allowance or inhibition conforming to the decision, the demodulated data stored in a buffer 26 is output responsive to the state of allowance of the decision signal 46 to be transferred to a radio frequency unit 18 and a demodulator 22, whereas the operation of the radio frequency unit 18 and the demodulator 22 is halted responsive to the state of inhibition of the decision signal 46. This allows for cessation of the operation at the time of startup of the demodulation more quickly than is heretofore possible. The operation of at least the radio frequency unit 18 and the demodulator 22 may thus be halted to save the electric power. In addition, the use of the buffer 26 storing several bytes of data therein and the subsequent decision on the satisfaction of the predetermined condition attain stabilized data transfer for a certain period of time, thus improving the communication quality.

In the present embodiment, the radio apparatus of the present invention is applied to a mobile phone terminal device 10. The parts or components not directly relevant to understanding the present invention will not be described nor shown in the drawings.

The mobile phone terminal device 10 generally includes a transceiver 12 and a controller 14, which are interconnected as shown in FIG. 1. The transceiver 12 has a receiving function of receiving a high frequency signal, propagated in air, demodulating the high frequency signal received, and outputting the so demodulated signal 52. In the following, signals are designated with reference numerals added to connection lines on which they are conveyed. The transceiver 12 also has a function of Manchester coding transmission data 56 supplied thereto and modulating the data to transmit the modulated data as a high frequency signal 38. For realizing these functions, the transceiver 12 includes an antenna 16, a radio frequency unit 18, an RSSI (Received Signal Strength Indicator) unit 20, a demodulator 22, a Manchester determiner 24, a buffer 26, a host interface (Host_TF) circuit 28, a Manchester encoder 30 and a modulator 32, which are interconnected as illustrated.

It should be noted that, in the absence of the Manchester encoder 30 and the modulator 32, the function of the mobile phone terminal device 10 would be restricted to the receiver function. In case the mobile phone terminal device 10 includes only the Manchester encoder 30 and the modulator 32 with respect to signal transmission, the function of the mobile phone terminal device 10 would be restricted to the transmitter function.

The antenna 16 has its characteristics of directivity, gain and impedance for a high frequency signal 32a, and the function of transmitting and receiving electromagnetic waves. The antenna 16 transfers received the high frequency signal 32a to the radio frequency unit 18. The antenna 16 also radiates the signal, transmitted from the radio frequency unit 18, in the form of high frequency signal 32a.

The radio frequency unit 18 has the down-converting function of extracting the high frequency signal from the carrier wave for thereby turning the high frequency signal into a base-band signal 36. The radio frequency unit 18 also has the up-converting function, which is the reverse of the down-converting function, that is, the function of up-converting a carrier wave modulated with the base-band modulation signal 38. The radio frequency unit 18 outputs the received signal on its output 34 to the RSSI unit 20. The radio frequency unit 18 down-converts the received signal 32a to output the signal 36 of the base-band frequency, thus converted, to the demodulator 22. In addition, the radio frequency unit 18 up-converts the modulated signal 38, transferred from the modulator 32, to drive the antenna 16 with a carrier wave modulated with the signal 38.

The RSSI unit 20 has the function of finding a value 40 of the strength of the electrical field of the signal 34 received from the radio frequency unit 18. The RSSI unit 20 converts the value 40 into a corresponding digital value which is output to the controller 14.

The demodulator 22 has the function of converting the analog signal 36 of the base-band frequency into a digital signal and demodulating the resulting digital signal. The demodulator 22 outputs digital data 42, thus demodulated, to the Manchester determiner 24.

The Manchester determiner 24 has the function of determining whether or not the Manchester code of received data has a predetermined data pattern to output a level signal corresponding to the result of the decision as a decision signal. The Manchester determiner 24 is supplied with a clock signal 44. The condition for decision in a data pattern of the Manchester code is that a predetermined binary state, i.e. “0” or “1”, does not persist for a period of time corresponding to three or more consecutive bits.

The period of time corresponding to three or more consecutive bits is prescribed by a value of three bits plus a, which value a is preferably set from system to system. Most preferably, the value of ax is set in consideration of the error tolerance level which may be set case by case.

The Manchester determiner 24 is responsive to a decision to the effect that violation of the condition for decision has occurred to output a decision signal 44 for “H” (logical high) level. The Manchester determiner 24 is responsive to a decision to the effect that the condition for decision has been met to output a decision signal 46 for “L” (logical low) level. The Manchester determiner 24 transfers the decision signal 46 to the radio frequency unit 18 and the demodulator 22. The operation of the radio frequency unit 18 and the demodulator 22 is controlled responsive to the decision signal 46. The Manchester determiner 24 also outputs the decision signal 46 via the host interface circuit 28 to the controller 14. Additionally, the Manchester determiner 24 is responsive to the clock signal 44 to decode the digital data 42, supplied thereto, so that one bit of the Manchester code corresponds to two bits of data, as will be described later. The Manchester determiner 24 outputs resulting demodulated data 48 to the buffer 26.

The buffer 26 has the function of temporarily storing the demodulated data 48 provided from the Manchester determiner 24 and of discarding the so stored demodulated data 48. The buffer 26 of the present embodiment is supplied in operation with an enable signal. The buffer 26 has its output operation controlled with negative logic by active low (L). The buffer 26 is responsive to the data pattern of the Manchester code satisfying the condition for decision to output the demodulated data 48 as demodulated data 50 to the host interface circuit 28. The buffer 26 is also responsive to a data pattern of the non-Manchester code which violates the condition for decision to discard the demodulated data 48.

The host interface circuit 28 has an input and output interfacing function between the transceiver 12 and the controller 14. The host interface circuit 28 is supplied with the decision signal 46 and the demodulated data 50. The host interface circuit 28 outputs the decision signal 46 and the demodulated data 50 in the form of received data 52 to a mating host interface circuit 54 of the controller 14. The host interface circuit 28 also receives transmission data 56, generated by the controller 14, and outputs the so received datain the form of transmission data 58 to the Manchester encoder 30.

The Manchester encoder 30 has the function of Manchester-encoding the transmission data 58, output from the host interface circuit 28. The Manchester encoder 30 transfers encoded transmission data 60 to the modulator 32.

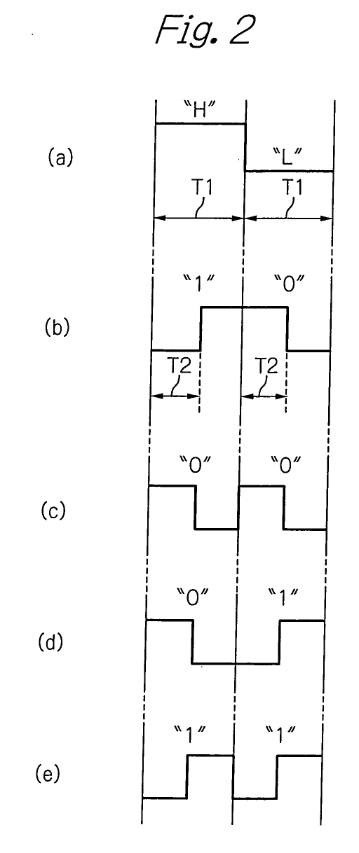

By Manchester coding, the time period equivalent to two consecutive bit intervals of the transfer rate is dealt with as one unit of time T1, as depicted in part (a) of FIG. 2. In accordance with the logic employed by the Manchester coding, a combination of logical values “0” and “1” each of which is sustained for one bit interval T2 of the transfer rate represents the logical value of the Manchester code. Specifically in FIG. 2, parts (b) to (e) show the logic for “1” and “0”, “0” and “0”, “0” and “1” and for “1” and “1”, respectively. In other words, in the Manchester code, there cannot occur consecutive three or more bits of logical value either “0” or “1”.

The modulator 32 converts the transmission data 58 into a corresponding analog signal and modulates the latter. The modulator 32 outputs the modulated analog signal 38 to the radio frequency unit 18.

The controller 14 includes a host interface circuit 54, a control circuit 62, a determiner 64 and a timer 66, which are interconnected as shown. The host interface circuit 54 has the function of input and output interfacing between the transceiver 12 and the controller 14. The host interface circuit 54 receives the decision signal 46 and the demodulated data 50 as the received data 52. The host interface circuit 54 outputs the received data 52 as received data 68 to the control circuit 62. The host interface circuit 54 also receives transmission data from the control circuit 62, as transmission data 68, while transferring the data as transmission data 56. The host interface circuit 54 also receives a count value 70 from the timer 66 and transfers the count value 70 in the form of transmission data 56.

The control circuit 62 includes a clock generator 72. The control circuit 62 has the function of generating an enable signal 74 which allows for the operation of the clock generator 72 responsive to the decision signal 46. The clock generator 72 is responsive to the enable signal 74 to generate the clock signal 44. By halting the operation of the clock generator 72, the power consumption of the mobile phone terminal device 10 may be suppressed. The control circuit 62 also has the functions of generating the transmission data 68 and of analyzing input data. Specifically, the control circuit 62 functions as verifying the quality of the demodulated input data, decoding command codes and storing data, and controls the various constituent components of the terminal device 10.

The determiner 64 has the function of verifying the aerial electromagnetic-wave environment on the basis of the value 40 received from the RSSI unit 20. The timer 66 serves as counting time to output a count value 70 to the transceiver 12 via the host interface circuit 54. The timer 66 also transfers the count value 70 to the control circuit 62 in a manner not specifically shown. The control circuit 62 generates an interrupt signal based on the count value 70 to control the booting of the mobile phone terminal device 10.

By the above configuration, the power consumption may be lower than with the configuration of the conventional mobile phone terminal device.

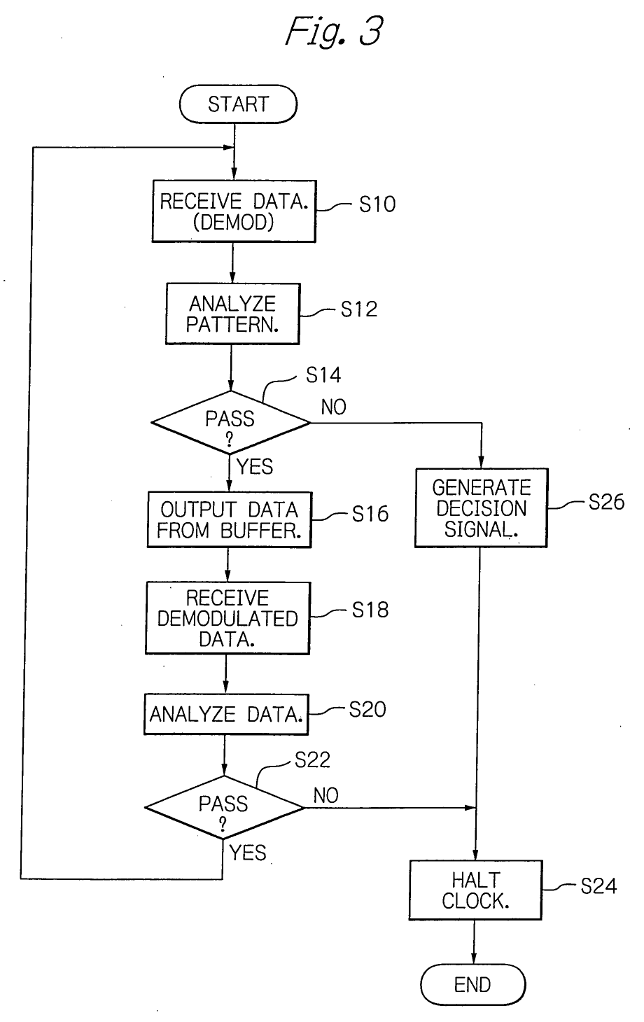

The operation of the mobile phone terminal device 10 will be described briefly with reference to FIG. 3. In the operation for signal transmission and reception, the operation of the radio frequency unit 18, the RSSI unit 20 and the determiner 64 is commenced basically in response to an interrupt by the timer 66. The radio frequency unit 18 receives the high frequency signal 32a. With the mobile phone terminal device 10, the signal 32a, received by the radio frequency unit 18, is converted in frequency to the base-band to be developed as the resulting signal 36 to the demodulator 22.

The demodulator 22 demodulates the received signal 36 and converts it to digital data to output the data 42 (step

The pattern is then analyzed (step S12). The Manchester determiner 24 verifies whether or not the demodulated digital data 42, supplied thereto, satisfies the condition for decision. The condition for decision is that there do not persist consecutive bits “0” or “1” for a time duration of three bits plus α. If there do not persist consecutive bits “0” or “1” for the time duration of three bits plus α, thus satisfying the condition for decision, the data pattern is deemed to be that of the Manchester code. In the present embodiment, αequals to zero.

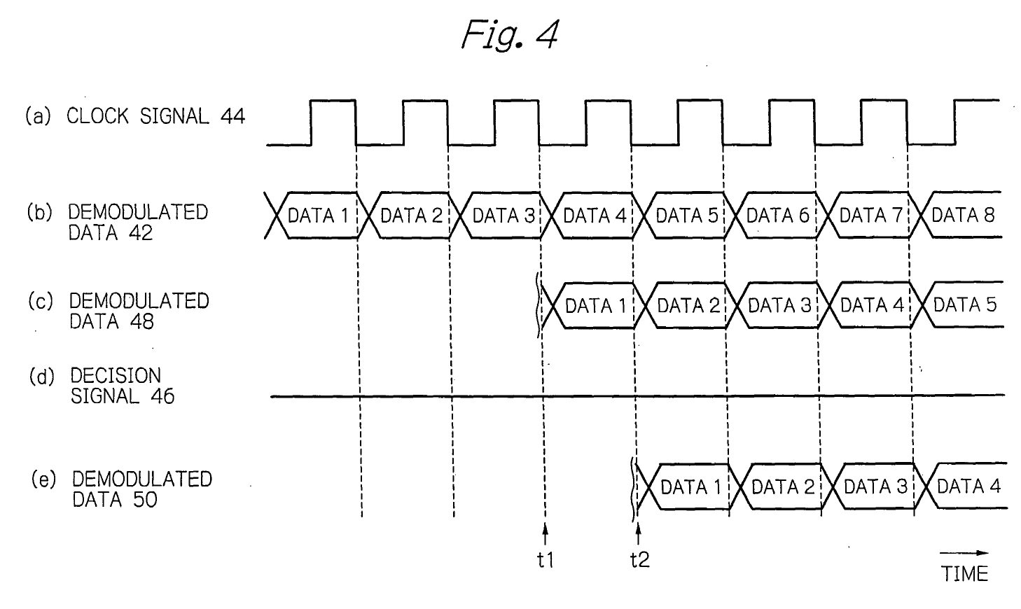

It is then determined whether or not passage of the demodulated data 48 is to be allowed (step S14). Based on the pattern analysis, if the condition for decision is met (YES), the Manchester determiner 24 outputs the demodulated input data 42 of FIG. 4, part (b), as demodulated data 48, shown in part (c), to the buffer 26, as from the timing of the negative-going edge of the clock signal 44 shown in part (a), that is, as from time t1, for example. The Manchester determiner 24 outputs the decision signal 46 at its level “L”, as shown in part (d). The level“L” decision signal thus output may maintain the mobile phone terminal device 10 operative in respect to the radio frequency unit 18 and the demodulator 22.

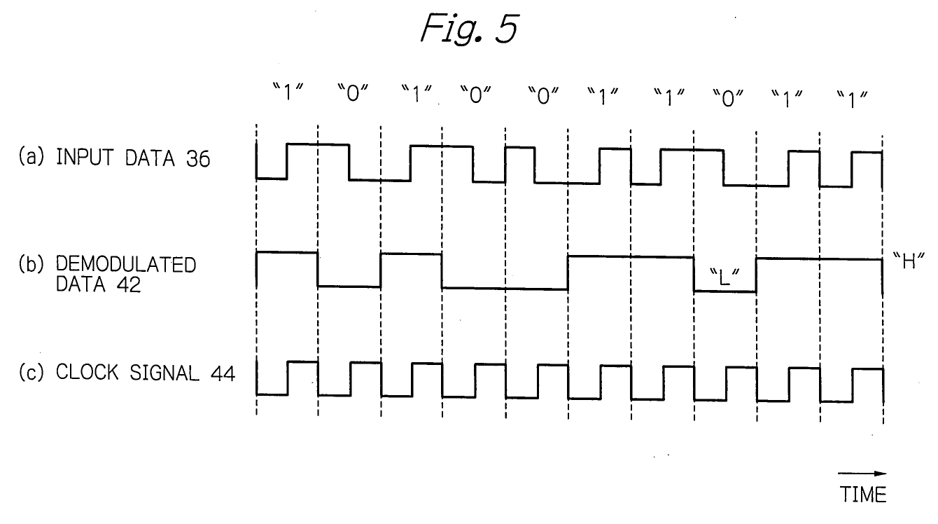

When the Manchester determiner 24 receives data of the Manchester code, shown in FIG. 5, part (a), on its input 42, it outputs two bits of demodulated data 42 shown in part (b). The demodulated data 42 is produced in timed with the clock signal shown in part (c). In this manner, the Manchester determiner 24 demodulates each bit of the Manchester code as two-bit data.

The demodulated data 48, stored in the buffer 26, is then output (step S16). The buffer 26 outputs the demodulated data 48 to the controller 14, as demodulated data 50, shown in FIG. 5, part (e), as from the timing of the negative-going edge of the clock signal 44, that is, as from time t2, for example. The controller 14 is booted at this stage.

The demodulated data 50, supplied to the controller 14, is received as received data 52 (step S18). In the controller 14, the received data 68, which is demodulated data, is supplied via the host interface circuit 54 to the control circuit 62.

The control circuit 62 analyzes the received data 68 as to whether or not the received data has been meant for and sent to the own mobile phone terminal device 10 in which the control circuit 62 is installed. If the results of analysis indicate the own device (YES), then the control circuit 62 reverts to the processing of continuing the data reception, that is, to the step S10. If the results of analysis indicate a terminal device other than the own device (NO), then the control circuit 62 proceeds to the processing of halting the clock signal 44, that is, to a step S24.

The control circuit 62 then transfers to the clock generator 72 a signal for inhibiting the enable signal 74 from being generated which controls the generation of the clock signal 44 (step S24). This halts the clock generator 72 from generating the clock signal 44 by. As the clock signal 44 has ceased to be generated, the operation of certain components of the mobile phone terminal device 10, such as the transceiver 12, is halted. Specifically, the operation is halted at least of the radio frequency unit 18, demodulator 22, buffer 26, host interface circuit 28 and control circuit 62 of the controller 14. After the halting of the operation, the signal transmission and reception is terminated.

In the above-described processing for determining whether or not the passage of demodulated data 48 is to be allowed (step S14), if the condition for decision is not met, that is, if the demodulated data 42 of “0” or “1” supplied persists for the time duration corresponding to three bits plus α (NO), then the Manchester determiner 24 deems the data pattern to be of the non-Manchester code, and in turn proceeds to the generation of the decision signal 46, that is, to a step S26.

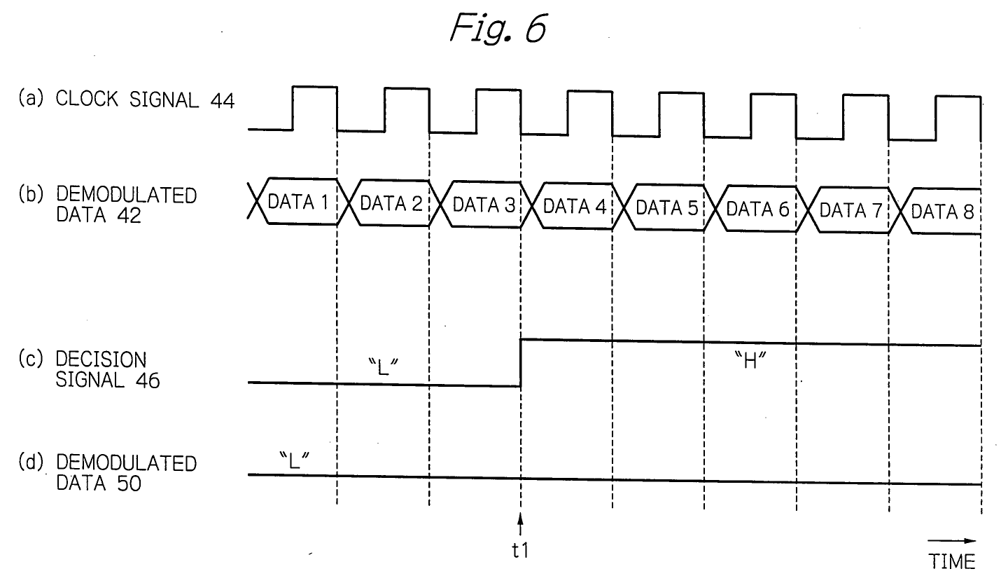

The Manchester determiner 24 then generates the decision signal 46 (step S26). Responsive to the result of decision, the Manchester determiner 24 sets the decision signal 46 to its level “H”, for use as the aforementioned enable signal, at the time t1 following the three bit intervals, as shown in FIG. 6, part (c). The buffer 26 already has the demodulated data 48 stored therein from the Manchester determiner 24, as shown in part (c). The buffer 26 discards the stored demodulated data 48. The result is that the demodulated data 50 as from the time t1 is not output any more, with the signal level of the demodulated data being “L”, as shown in part (d).

The decision signal 46, produced under this condition, is transferred to the radio frequency unit 18 and the demodulator 22, to halt the operation thereof. The decision signal 46 is also transferred to the controller 14. Responsive to the decision signal 46, the mobile phone terminal device 10 proceeds to the ceasing of the clock signal 44 by the control circuit 62, described above, that is, to the step S24. The processing of halting the clock signal 44 is as described previously.

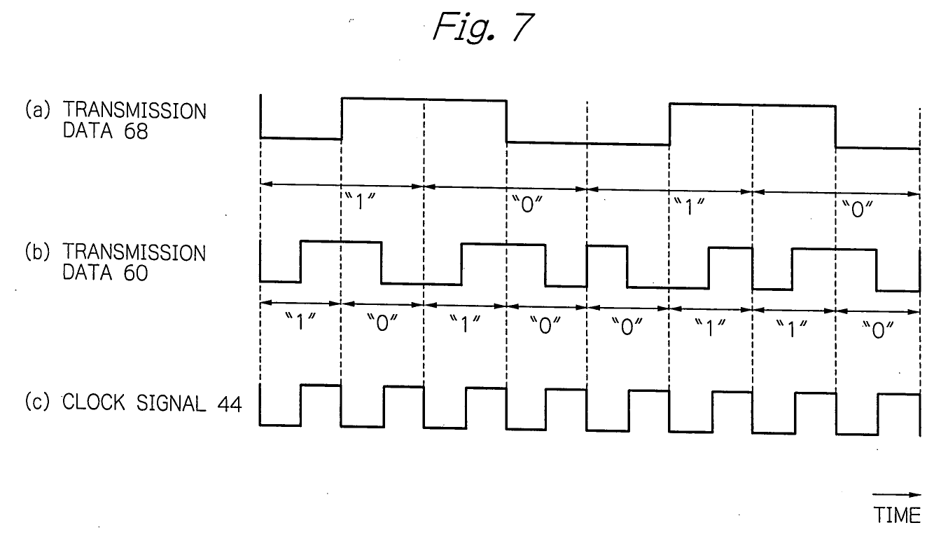

Next, transmission of the transmission data 68, produced by the control circuit 62 of the controller 14, will be described. The control circuit 62 outputs the transmission data 68 of the Manchester code thus produced via the host interface circuits 54 and 28 to the Manchester encoder 30, as shown in FIG. 7, part (a).

The Manchester encoder 30 is responsive to the clock signal 44 supplied to produce the transmission data 60 shown in FIG. 7, part (b). The transmission data 60, obtained on Manchester encoding, with the use of the clock signal 44 supplied, is of a Manchester code having its period one-half as long as that of the transmission data 68.

In this manner, the transmission data 68, obtained on Manchester coding by the control circuit 62, is not used, but instead the transmission data 58 supplied is converted into the Manchester code by the Manchester encoder 30 of the transceiver 12, with the use of the clock signal 44, and transferred as transmission data 60 to the modulator 32. Thus, in comparison to the conventional system transmitting data of the pattern of the Manchester code generated by its control circuit, the illustrative embodiments requires, as seen from FIG. 7, part (b), one-half operational time for producing transmission data of the pattern of the Manchester code, thereby relieving the load of the control circuit 62.

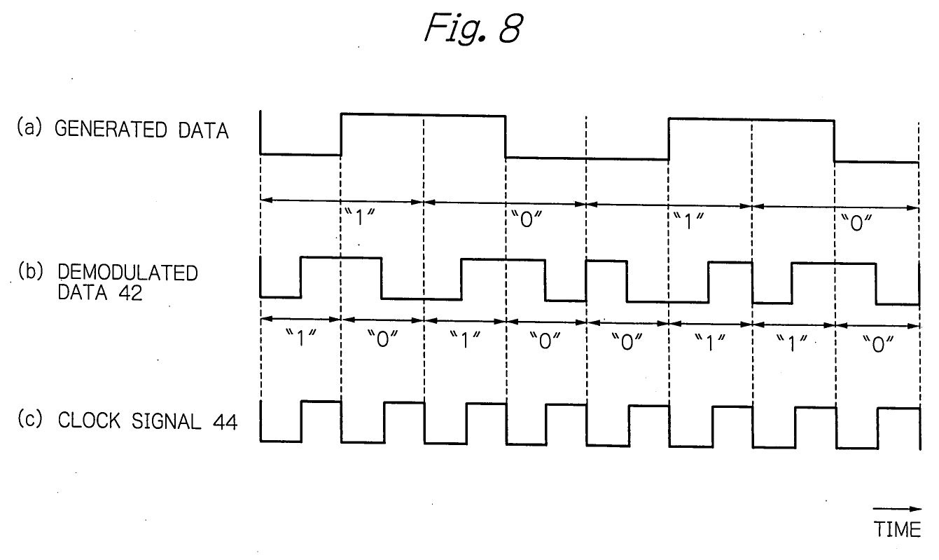

The conventional system is structured such that, when the Manchester code is produced in signal reception by its control circuit and the data so generated is processed with pattern analysis, data of the Manchester code is also generated, as shown in FIG. 8, part (a), and analysis is made on the basis of the so generated data. The mobile phone terminal device 10 of the present embodiment is, however, structured such that the demodulated digital data 42 is supplied to the Manchester determiner 24, so that the time needed for the pattern analysis in the Manchester determiner 24 is one-half as long as the pattern analysis otherwise implemented by the control circuit 62, as seen from FIG. 8, part (b). Thus, the operation of the control circuit 62 by pattern analysis is controlled as described above so that the load on the control circuit 62 may be relieved accordingly.

Although the radio apparatus of the present invention is applied to the mobile phone terminal device 10, with the instant embodiment, it may also be applied to any sorts of communication equipment in which data has to be converted for purpose of improving the communication quality. The present invention is also applicable to types of communication equipment exercising control in connection with pattern analysis of data, and startup or operation control of other components of the equipment.

With the above-described constitution, in which the pattern of the demodulated data in the Manchester code is analyzed with the use of the Manchester determiner 24, at least the operation of the radio frequency unit 18 and the demodulator 22 maybe halted, at the time of startup of demodulation, subject to decision to the effect that the data pattern is not of the Manchester code, such as to diminish the power consumption. In addition, the host interface circuit 28 and the control circuit 62 are not caused to start the operation thereof, thereby making it possible to diminish the power consumption which would otherwise be inherent to the startup of the operation of the host interface circuit 28 and the control circuit 62.

Additionally, the buffer 26 is used for storing several bytes therein which are subsequently given the determination, thereby accomplishing stabilized data transfer for a certain period of time. This reduces the load otherwise incurred on the control circuit 62, thereby improving the communication quality.

Moreover, in comparison to the conventional control circuit analyzing the pattern of Manchester code, the illustrative embodiment may analyze the Manchester code pattern with a period of time required therefor reduced half. Thus, with the mobile phone terminal device 10, signal reception may be halted promptly upon a reception of the non-Manchester code pattern. In a similar manner, the provision of the Manchester encoder 30 allows the time for generating data of the Manchester code pattern to be halved, with the result that the load on the control circuit 62 may be diminished.

In accordance with the invention, the following aspects are provided:

1. A power controlling method for suppressing power consumption in reception of a high frequency signal, comprising the steps of:

converting a received demodulated signal into demodulated digital data;

determining whether or not the demodulated digital data satisfies a predetermined condition for decision which exploits a feature proper to Manchester code;

generating a decision signal representing a state of allowance or inhibition resulting from decision;

outputting the demodulated digital data responsive to the state of allowance of the decision signal; and

halting operation of frequency conversion and said step of converting responsive to the state of inhibition of the decision signal.

2. The method in accordance with aspect 1, wherein the condition for decision includes the inhibition set responsive to consecutive three or more bits of the data of a same logical level.

3. The method in accordance with aspect 1, further comprising the step of inhibiting an allowance signal for allowing generation of a clock signal responsive to the state of inhibition of the decision signal.

The entire disclosure of Japanese patent application No. 2006-042321, filed on Feb. 20, 2006, including the specification, claims, accompanying drawings and abstract of the disclosure, is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A radio apparatus for receiving a high frequency signal, comprising:
a frequency converter for converting the high frequency signal into a signal of a base-band frequency and for outputting a converted signal;
a demodulator for demodulation with the converted signal and for converting a demodulated signal into demodulated digital data;
a determiner for determining whether or not the demodulated digital data satisfies a predetermined condition for decision which exploits a feature proper to Manchester code, and for generating a decision signal representing a state of allowance or inhibition resulting from the decision; and
a memory for temporarily storing the demodulated digital data from said determiner,
the demodulated digital data stored in said memory being output responsive to the state of allowance of the decision signal, the decision signal being transferred to said frequency converter and said demodulator to halt operation of said frequency converter and said demodulator responsive to the state of inhibition of the decision signal.

2. The apparatus in accordance with claim 1, wherein the condition for decision includes the inhibition set responsive to consecutive three or more bits of data of a same logical level.

3. The apparatus in accordance with claim 1, further comprising:
a controller for controlling said apparatus; and
an interfacing circuit for interconnecting said memory to said controller,
said radio apparatus controlling the operation of said controller and said interfacing circuit responsive to the decision signal.

4. A radio apparatus for transmitting and receiving a high frequency signal, comprising:
a frequency converter for converting the high frequency signal into a signal of a base-band frequency, for outputting a converted signal and for converting a transmission signal of the base-band frequency into the high frequency signal;
a demodulator for demodulating a converted signal and for converting the demodulated signal into demodulated digital data;
a determiner for determining whether or not the demodulated digital data satisfies a predetermined condition for decision which exploits a feature proper to a Manchester code and for generating a decision signal representing a state of allowance or inhibition associated with the decision;
a memory for temporarily storing the demodulated digital data from said determiner;
an encoder for encoding transmission data for transmission into Manchester code; and
a modulator for modulating the transmission data encoded to output resulting modulated data to said frequency converter,
the demodulated digital data stored in said memory is output responsive to the state of allowance of the decision signal, the decision signal being transferred to said frequency converter and said demodulator, operation of said frequency converter and said demodulator being halted responsive to the state of inhibition of the decision signal.

5. The apparatus in accordance with claim 4, wherein the condition for decision includes the inhibition set responsive to consecutive three or more bits of the data of a same logical level.

6. The apparatus in accordance with claim 4, further comprising:
a controller for controlling said apparatus; and
an interfacing circuit for interconnecting said memory to said controller,
said radio apparatus controlling the operation of said controller and said interfacing circuit responsive to the decision signal.
